(19) United States
(12) Patent Application Publication
(10) Pub. No.: US 2020/0228646 A1
(43) Pub. Date: Jul. 16, 2020

(54) SYSTEMS AND METHODS FOR DISTRACTED DRIVING PREVENTION

(71) Applicant: Automatic Labs Inc., San Francisco, CA (US)

(72) Inventors: Scott Allen Hotes, Martinez, CA (US); Mitch Ozer, San Francisco, CA (US); Ralph Acosta, Los Angeles, CA (US); Manhattan Perry, Los Angeles, CA (US)

(21) Appl. No.: 16/739,903

(22) Filed: Jan. 10, 2020

Related U.S. Application Data
(60) Provisional application No. 62/790,850, filed on Jan. 10, 2019.
(60) Provisional application No. 62/857,658, filed on Jun. 5, 2019.

(51) Int. Cl. H04M 1/725; H04W 4/48

(52) U.S. Cl. CPC H04M 1/72577; H04M 1/7253; H04W 4/48; H04M 1/72569

(57) ABSTRACT

Systems and methods are presented for preventing distracted driving. Exemplary implementations include identifying one or more mobile devices associated with the driver of a vehicle and restricting access to the identified mobile devices while driving, and restoring access to the identified mobile devices when not driving.

### CROSS-REFERENCE TO RELATED APPLICATION

This application claims the benefit of U.S. Provisional Application Nos. 62/790,850, filed Jan. 10, 2019, and 62/857,658, filed Jun. 5, 2019, the contents of which are incorporated by reference in its entireties.

### FIELD OF THE INVENTION

The current inventions generally relate to systems and methods for controlling one or more applications running on a user device that is located within a vehicle and while a user of the device is operating the vehicle. Various exemplary embodiments are described below, such as systems and methods that may monitor usage of the user device and/or identify that the user is operating the vehicle and, based on such monitoring and identification, prevent access to one or more applications running on a user device.

### BACKGROUND

In recent years, there has been a tremendous increase in the use of user devices, such as mobile phones (e.g., smart phones) and tablets (e.g., iPads), related to taking calls, texting, music streaming, emailing, navigation and other applications. Along with this general increase in using these types of devices, significantly more drivers have begun to use such user devices while operating a vehicle, resulting in an increase in distracted driving and unsafe driving practices and conditions. For example, a driver looking at or using a mobile phone may be more likely to cause an accident because the driver may be distracted by paying attention to the application on the mobile phone. This is a particularly problematic issue when it comes to new drivers, including teenage drivers, who need to pay more attention and have higher levels of concentration when driving.

To address this issue, some prior systems, such as those described in US 2013/0303143, use a driving mode lock screen for a mobile device that is present in a vehicle. Under this prior art system, a safe driving service remotely activates a safe driving mode of the mobile device which disables some features of the mobile device while the safe driving mode is activated. However, remotely activating a safe driving mode when knowing the operating of a vehicle may potentially use a mobile device and be distracted or through monitoring usage of a mobile device of a driver is not enough. For example, this prior art system requires knowing that a mobile device user will be operating a vehicle so that the safe driving mode may be remotely activated or relying on the device user to activate the safe driving mode prior to operating a vehicle. In both exemplary circumstances, there will likely be many occasions when the safe driving mode is not activated. Thus, a need exists for systems and methods that can provide an effective solution for minimizing distracted driving by encompassing, for example, prevention of unsafe driving practices (such as distracted driving), enforcement of safe driving practices, awareness related to safe driving practices, increased engagement with registered users and added drivers of the system when they are not in the vehicle, and utilization of driving data from various in-vehicle systems (e.g., sensors, event recorders, intelligent user interfaces, on-board diagnostic (OBD) tools, infotainment systems, plug-in adapters, etc.) and user devices.

### SUMMARY

The present inventions include a distracted driving prevention system that can identify one or more devices that are likely to be used by the driver during operation of a vehicle, and restricting access to those devices to minimize distracted driving and improve safety. By restricting access to the devices that are likely to be used by the driver only when the vehicle is being driven (e.g., when the car is running), the distracted driving prevention system can automatically and effectively ensure that the distracted driving is minimized during the drive, without remote activation or other user input.

The distracted driving prevent system can use, in some embodiments, aspects of driving data and contextual data related to driving conditions from various sources, rules, and user device application restrictions to reduce distracted driving, encourage safe driving practices, and provide parents and/or legal guardians with ways of applying rules related to safe driving practices for their family, including family members who are new drivers. The distracted driving prevention system can use various forms of data to determine if a user's device or the applications or software programs operating thereon, such as “apps” on a mobile phone, should be subject to some form of restricted use or disablement in view of the available data. Such restricted use may include, for example, making one or more applications on the user's device inoperable or limiting the functionality of one or more aspects of an application on the user's device.

Sources of driving data that can be utilized by the system for purposes of controlling or restricting access to a mobile device include data from in-vehicle systems and/or user devices such as (for example) Global Positioning System (GPS) location data, trip details, route details, vehicle driving speed, acceleration, engine utilization, sequence of driving events, braking, engine revolutions per minimum (RPM), throttle, fuel injection rate, odometer reading, gyroscope data etc. The distracted driving prevention system may analyze user habits (e.g., amount of driving, rest time, driving time of day, driving day of week, road familiarity, similarity with a baseline vehicle, commuting, time of year, length of trip, etc.), and/or contextual data related to real-time audio feedback, post-trip feedback, weekly summaries, weekly insights, driving conditions (e.g., weather, traffic, type of driving location, speed limit, etc.), time of driving, and/or driving route to detect unsafe and/or distracted driving durations. The driving conditions may be collected from external sources including websites, real-time traffic data as well as other sources of information.

The inventive distracted driving prevention systems and methods utilize comprehensive, engaging, and computationally efficient mechanisms by using, for example, unique methods for driving pattern recognition, anomaly detection, crash detection, rule violation alerts (e.g., alerts associated with a driver violating a driving rule, such as a boundary rule, speed limit rule, and/or curfew rule), tamper alerts (e.g., alerts associated with the distracted driving prevention system being circumvented), trip start/end notifications, generating and recognizing driver fingerprint data, and detecting unsafe driving behaviors. The distracted driving prevention system may combine various data inputs and mechanisms to generate comprehensive multivariate features that can be combined with computationally efficient models using machine learning, and/or data mining to provide a user-friendly, responsive, and engaging user experience that reduces distracted driving behaviors. The innovative distracted driving prevention system may analyze and combine the data from the various sources for programmatically improving a driver's safety rating when a distracted driving restriction is placed on the driver's mobile device.

In the event of an emergency (e.g., a crash or near-crash), the distracted driving prevention system may automatically lift and/or disable any distracted driving restrictions placed on the driver's mobile device. Emergency situations may allow a driver to override some or all of restrictions placed on the mobile device. The emergency events may be detected based on analyzing driving data, context driven data, and/or third-party data and the distracted driving prevention system may verify this detection based on driver feedback to notifications and/or alerts.

Systems, methods, and non-transitory computer readable media for the inventive distracted driving prevention system can be configured, in some embodiments, to alert vehicle operators to distracted driving scenarios. For example, the system can be configured to detect when the device(s) that are likely to be used by the driver are being used (e.g., picked up, accessed, looked at, etc.), and display an alert on the device(s), for example, to warn the user that the device(s) should not be operated on while driving. Vehicle operators and mobile device users will likely benefit from educational opportunities that will arise from being informed of these distracted driving scenarios that will help build awareness and knowledge related to safe driving practices, driving regulations, and/or ways of reducing distracted driving behaviors. By alerting vehicle operators to distracted driving scenarios through the distracted driving prevention system, drivers will also likely be encouraged to set good examples of driving behavior (e.g., parents may be encouraged to set good examples for their children who have become new drivers), leverage habit-forming techniques, and/or encourage discussion amongst vehicle operators about safe driving practices.

The present invention also provides various methods and techniques that enables access restriction to the devices while improving ease of installation of the portion of the system on a user device (e.g., minimizing undesirable/burdensome installation steps), for example, with or without the need to erase all data on the devices.

### BRIEF DESCRIPTION OF DRAWINGS

The above and other aspects and advantages of the invention will become more apparent upon consideration of the following detailed description, taken in conjunction with accompanying drawings briefly summarized below. Each of the drawings have characters (e.g., numbers or letters) identifying one or more components of the inventions and each of the same referenced characters refer to the same components throughout the figure:

FIG. 1 shows an exemplary system in accordance with various embodiments;

FIG. 2 shows an example of in-vehicle system in accordance with various embodiments;

FIG. 3 shows an example of a plug-in adapter in accordance with various embodiments;

FIGS. 4A-E show examples of a user interface of the distracted driving prevention system in accordance with various embodiments;

FIGS. 5A-C show examples of a user interface of the distracted driving prevention system in accordance with various embodiments;

FIGS. 6A-B show examples of a user interface of the distracted driving prevention system in accordance with various embodiments;

FIGS. 7A-B show examples of a user interface of the distracted driving prevention system in accordance with various embodiments;

FIGS. 8A-B show examples of a user interface of the distracted driving prevention system in accordance with various embodiments;

FIGS. 9A-B show examples of a user interface of the distracted driving prevention system in accordance with various embodiments;

FIG. 10A-B show examples of process flows for restricting usage of mobile devices for a driver in accordance with various embodiments;

FIG. 11 shows an example of an illustrative flowchart for configuring rules and/or alerts for additional drivers in accordance with various embodiments;

### DETAILED DESCRIPTION

The inventive methods and systems, include specific computer implementations for identifying a driver, identifying distracted driving behavior, estimating a distracted driving rating, and/or a driver safety rating for a plurality of drivers. Such systems and methods may relate to and include identifying a plurality of registered subscribers located in the vehicle and determining which registered subscriber is the driver. The systems and methods may then lock (disable access to) the user device and/or restrict usage of the user device to reduce a likelihood of distracted driving behavior.

In some embodiments, the driver's user device may be identified based on a proximity of the user device to a radio beacon. For example, a Bluetooth beacon can be provided in the vehicle to detect and determine the relative proximity and/or location of Bluetooth-enabled user devices with respect to the Bluetooth beacon. In some embodiments, the system may identify the mobile device using GPS location tracking instead of or in combination with a radio beacon.

When one or more user devices are detected, the system can be configured to determine which user device is most likely to be in the proximity of the driver seat, and thus most likely to be used by the driver. In some embodiments, the system can be configured to disable or limit one or more functionalities of the determined user device as described herein. In some embodiments, the system can be configured to disable one or more user devices that are within a certain range of the Beacon.

In some embodiments, the driver may be identified based on a driver “fingerprint” associated with a driver of the vehicle. The driver fingerprint may be based on, for example, analyzing numerous aspects of raw driving data in combination with driving conditions received at a driving data server and from one or more sensors, car infotainment systems, and/or other devices, such as mobile phones and vehicle adapters. The raw data may include engine revolutions per minutes, odometer readings, global positioning system data, maneuver intensities, braking occurrences, gyroscope data, accelerometer data, and/or engine diagnostics data. By identifying the driver and the respective user device, the system may disable or restrict usage of one or more applications on the user device to prevent the driver from being distracted by the user device while driving.

A driving data server may receive data (e.g., raw driving data, contextual data, and driver related data) for determining a measure of distracted driving for a plurality of drivers and may provide notifications and/or suggestions for reducing an amount of distracted driving behavior. The data can be received from one or more sources including, for example, vehicle telematics units, vehicle sensors, vehicle plug-in adapters, smart devices, accelerometers, gyroscopes, GPS data, road sensors, traffic data feed information, weather data, emergency alerts, social-media feeds, etc. The received data can be stored, for example, in memory of a centralized server.

Some embodiments of the present systems and methods can analyze the received data to determine a distracted driving score and/or a relative driver safety rating for a particular driver, through the use of various models with different and various parameters. Various content databases including a driver database can be used to store the raw driving data, distracted driving information, driver safety rating, driver fingerprint information and other driver and/or vehicle related information. Real-time updates of the data to estimate the amount of distracted driving may be received by the centralized server of the distracted driving prevention system to help provide the most robust and engaging system for reducing distracted driving and improving safe driving habits.

It is noted that the terms “distracted driving prevention system” are used herein to refer broadly to a wide variety of user devices, storage devices, driving data servers, sensors, in-vehicle systems, and other electronic devices for purposes of minimizing or preventing distracted driving by vehicle operators. It is also noted that the term “driver database” is used herein to refer broadly to a wide variety of digital data, content databases, portions of content databases, online data, offline data, and/or other types of data. Content databases can also include files, folders or other mechanisms of grouping content databases together based on different driving behaviors, such as collections of safe drivers, risky drivers, etc.

In general, the order of the steps of the disclosed processes may be altered within the scope of the invention. Unless stated otherwise, a component such as a processor or a memory described as being configured to perform a task can be implemented as a general component that is temporarily configured to perform the task at a given time or a specific component that is manufactured to perform the task. As used herein, the term “processor” refers to one or more devices, circuits, and/or processing cores (e.g., such as a specialized processor) configured to process data, such as computer program instructions.

A detailed description of one or more embodiments of the inventions is provided below along with accompanying figures that illustrate the various aspects of the invention. The referenced figures are only for the purpose of illustrating embodiments, and are not to be construed as limiting the present invention. The invention is described in connection with such embodiments, but the invention is not limited to any particular embodiment. Numerous specific details are set forth in the following description in order to provide a thorough understanding of the invention and these details are provided by way of example and the invention may be practiced without some or all of these specific details. For the purpose of clarity, technical material that is known in the technical fields related to the invention has not been described in detail so that the invention is not unnecessarily obscured. Various inventive features are described below that can each be used independently of one another or in combination with other features.

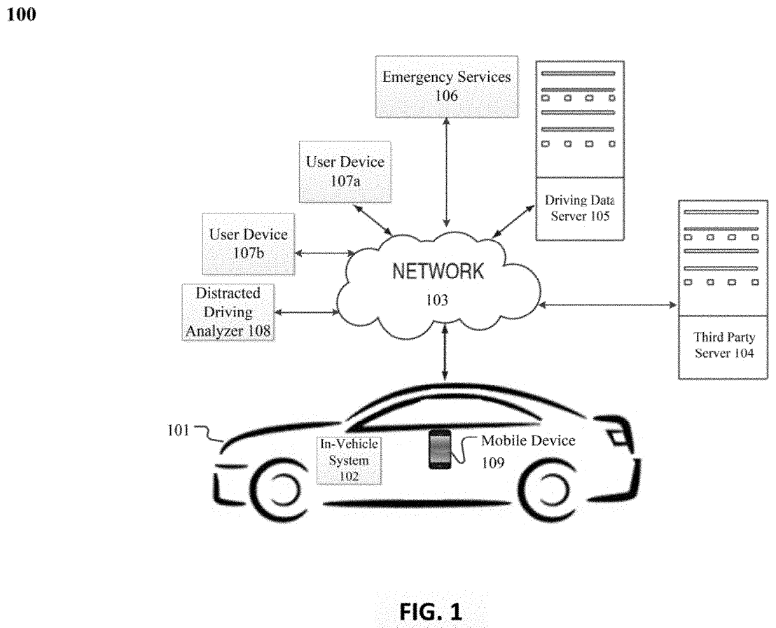

FIG. 1 shows an exemplary distracted driving prevention system 100 in accordance with various embodiments. The distracted driving prevention system 100 includes, for example, a vehicle 101, an in-vehicle system 102, third party server 104, driving data server 105, emergency services 106, and distracted driving analyzer 108. As depicted in FIG. 1, components of the distracted driving prevention system can communicate with one another via network 103.

The distracted driving prevention system can also include one or more user devices (e.g., desktop, tablet, laptop, smart phone, tablet) such as user devices 107a and 107b and mobile device 109 that can be controlled by distracted driving prevention system 100 via, for example, application(s) (“app”) installed on the devices. Although user devices 107a and 107b, and mobile device 109 can be similar mobile devices, the term mobile device is being used herein to refer to the device that is in the vehicle (or the device that is identified to be likely used by the driver).

The distracted driving prevention system 100 can communicate by sending and/or receiving data over network 103 to one or more components of the distracted driving prevention system 100 illustrated in FIG. 1.

Network 103 can be any network, combination of networks, or network devices that can carry data communication. For example, network 103 can be any one or any combination of LAN (local area network), WAN (wide area network), telephone network, wireless network, point-to point network, star network, token ring network, hub network, or any other configuration.

Network 103 may support any number of protocols, including but not limited to TCP/IP (Transfer Control Protocol and Internet Protocol), HTTP (Hypertext Transfer Protocol), WAP (wireless application protocol), etc. For example, user device 107a and user device 107b (together 107) can communicate with Network 103 of the distracted driving prevention system 100 using TCP/IP, and, at a higher level, use a web browser to communicate with a web server (not shown) using HTTP. Examples of implementations of the web browser, include, but are not limited to, Google Inc. Chrome™ browser, Microsoft Internet Explorer®, Apple Safari®, Mozilla Firefox, and Opera Software Opera.

A variety of devices, such as devices 107a, 107b, 109, and other wireless devices, can communicate with other elements of the distracted driving prevention system 100, including, but not limited to, desktop computers, servers, mobile computers, mobile communication devices (e.g., mobile phones, smart phones, tablets, etc.), televisions, set-top boxes, and/or any other network enabled device. Although the user devices 107a and 107b are illustrated for description purposes, persons of ordinary skill in the art will recognize that any number of devices can be used and supported by the distracted driving prevention system 100. For example, various types of devices of the distracted driving prevention system 100 can include, but are not limited to, smart phones, mobile phones, tablet computers, personal digital assistants (PDAs), laptop computers, digital music players, and/or any other type of user device capable of including a touch-sensing display interface. Various touch-sensing display interfaces can include, but are not limited to, liquid crystal displays (LCD), monochrome displays, color graphics adapter (CGA) displays, enhanced graphics adapter (EGA) displays, variable-graphics array (VGA) displays, or any other display, or any combination thereof. In some embodiments, the touch-sensing display interface can include a multi-touch panel coupled to one or more processors to receive and detect gestures. Multi-touch panels, for example, can include capacitive sensing mediums having a one or more of row traces and/or driving line traces, and one or more column traces and/or sensing lines. Although multi-touch panels are described herein as one example for touch-sensing display interface, persons of ordinary skill in the art will recognize that any touch-sensing display interface can be used.

User devices 107a and 107b may be used for displaying a graphical user interface (GUI) related to the distracted driving prevention system that provides an interface for initializing a distracted driving application, adding driver and corresponding vehicle information, setting driving rules, configuring alerts and/or tamper notifications, and monitoring distracted driving applications running on other devices, such as mobile device 109. User devices 107a and 107b can be used for collecting driver data such as data from social media profiles, travel interests, travel patterns, and other online and offline activities. The mobile device 109 can be used for collecting raw driving data (e.g., GPS location data, trip details, route details, vehicle driving speed, acceleration, engine utilization, sequence of driving events, braking, RPM, throttle, fuel injection rate, odometer reading, and/or gyroscope data) associated with the registered driver of the vehicle.

Third party servers such as server 104 can be utilized, in some embodiments, to provide additional context-based information (e.g., real-time traffic, time, terrain, road speed limits, real-time weather, real-time average road segment speed, congestion information, historical precipitation data, visibility, wind speed, temperature, etc.) that can be of interest for distinguishing between distracted driving indicators and other driving indicators associated with inclement weather conditions, congested traffic, and/or difficult driving terrain (e.g., hilly or off-road driving). By analyzing the driving data in the context of context-based information, the present systems and methods can detect deviations from typical driving behaviors as an indicator of potential distracted driving. For example, if a user is swerving under normal conditions (e.g., fair weather, no traffic, etc.) the systems and methods can be configured to classify the swerving as a result of distracted driving. In contrast, if the swerving occurs during poor conditions, such as inclement weather (e.g., a snow storm), the present systems and methods can be configured to classify the swerving as a result of the poor road conditions rather than distracted driving.

In-vehicle system 102 (e.g., vehicle telematics unit, plug-in adapter, infotainment system, vehicle sensors, GPS, original equipment manufacturer (OEM) data such as airbag deployment, seatbelt sensors, etc.) can provide driver data that includes driver preferences, additional measurements related to acceleration, number of hard brakes over a selected time duration (e.g., deceleration from 20 mph to 0 mph in approximately 3 seconds), sudden maneuvering, distance driven on familiar (e.g., road visited a couple of times per week) and/or unfamiliar roads, driving time on weekends, driving time at night, etc.

Analysis of the raw driving data, context-based information, third party server data, and other data described above may be performed by analyzer 108 and used for generating corresponding driver data profiles, determining an amount of distracted driving, assigning and/or modifying a driver safety rating, driving habits, suggestions related to reducing the amount of distracted driving and improving the driver safety rating, user selectable privacy features, and/or generate a unique driver fingerprint that can help identify a driver. These data can be stored, for example, in driving data server 105.

In some embodiments, the driving data server and third party server data can be analyzed by distracted driving analyzer 108 and used by distracted driving prevention system 100 to create a corresponding driver data profile that is stored in driving data server 105. The analyzer 108 can include computational procedures for determining a robust, accurate, and reliable distracted driving rating and/or a driver safety rating.

In some embodiments, distracted driving analyzer 108 can be configured to detect, for example, whether mobile device 109 is in the hand of the driver, such as by determining whether the screen is on, whether data is being transmitted or received by the mobile device, the type of data, whether there are other people/devices in the car, whether the user is listening to music or using a navigation application on the device.

The driver data can be stored locally within a locally accessible file system of the distracted driving prevention system's network and/or stored remotely in one or more cloud storage servers. The analysis of the data from the driving data server and the third party server can provide additional metrics for estimating a measure of safe driving behavior. For example, the distracted driving prevention system can verify that some part of a total trip driving time involved driving on unfamiliar roads and extended to late night hours.

Based on the analysis of the various forms of data described above, in some embodiments, the system can also recommend and/or restrict access to devices that are associated with a driver.

By way of an exemplary embodiment, driving data server 105 and/or analyzer 108 can be configured to identify an emergency situation, such as a crash or near crash-event, and automatically disable restrictions placed on the usage of the mobile device 109. In some embodiments, driving data server 105 and/or analyzer 108 can be configured to monitor and detect when the vehicle experiences a rapid energy dissipation using one or more available vehicle and/or mobile device data such as accelerometer data, speed, GPS, and/or other data. Based on the identification of an emergency situation, in some embodiments, when distracted driving prevention system 100 detects an emergency situation, system 100 can send instructions to mobile device 109 to undo any disablement and/or usage restriction that had been placed on the mobile device.

In some embodiments, distracted driving prevention system 100 may further contact emergency services 106 in the event of an emergency situation. The driving data server 105 and the distracted driving analyzer 108 may be used interchangeably and/or in combination for carrying out the methods and systems described herein. In some embodiments, the distracted driving analyzer 108 can be a part of the driving data server 105. In some embodiments, the distracted driving prevention system 100 may allow the driver to override the restrictions placed on the mobile device if the system determines that the vehicle is at a stand-still or the ignition is turned Off.

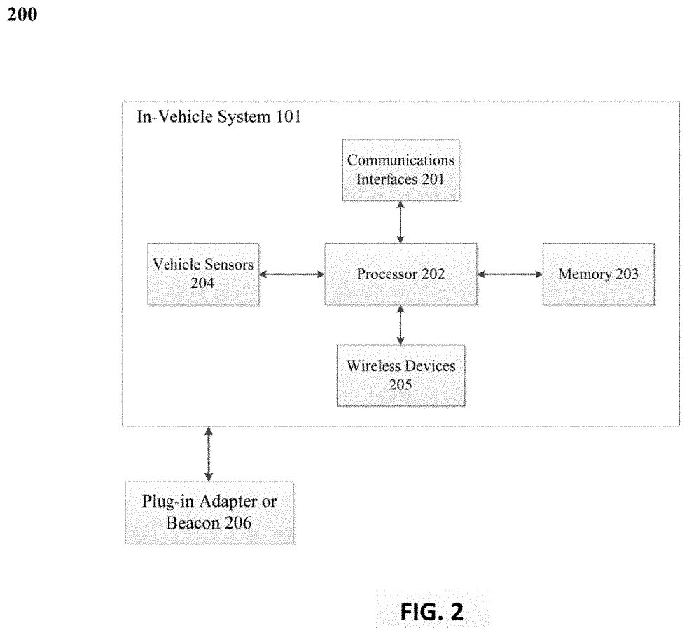

FIG. 2 shows an example of an in-vehicle system 102 connected to a plug-in adapter or Bluetooth beacon 206, to enable one or more features of the present invention. The in-vehicle system 102 and Bluetooth beacon 206 can include and be connected via a communications interface 201 (cellular interface, Bluetooth, Wi-Fi, etc.), processor 202, memory 203, vehicle sensors 204 (accelerometers, gyroscopes, fuel gauges, engine sensors, windshield rain sensors, brake system sensors, etc.), and wireless devices 205 (wireless modems, SIM cards, GPS, vehicle-to-vehicle communication devices, etc.). The plug-in adapter or Bluetooth beacon 206 can be a hardware device capable of communicating with the in-vehicle system 101, user devices (e.g., cellular phones, laptops, etc.), emergency device, and remote servers including the driving data server 105 and the third party server 104. The plug-in adapter or Bluetooth beacon 206 can receive raw driving data from the in-vehicle system 101 (which have been obtained from various sources) and send the raw driving data for further processing and analysis to the driving data server 105 and/or other registered devices that are part of the distracted driving prevention system 101.

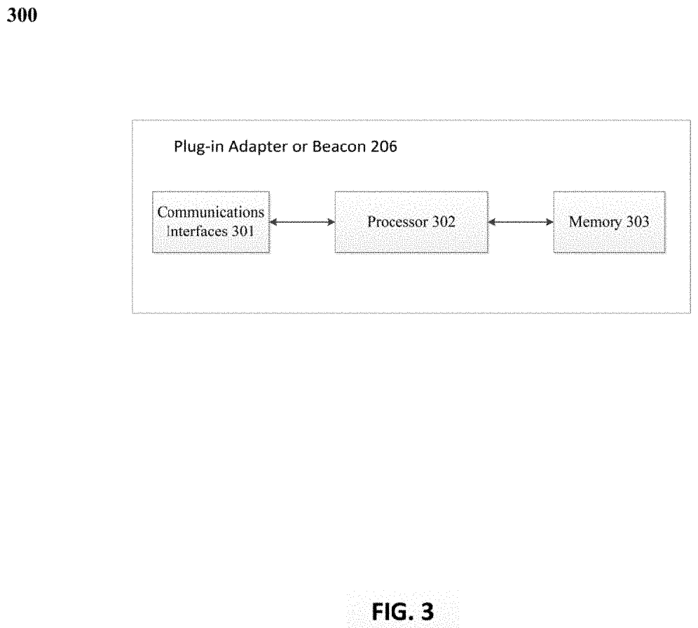

FIG. 3 shows an exemplary illustration of the plug-in adapter or Bluetooth beacon 206 that includes a communications interface 301, processor 302, and memory 303. The Bluetooth may can wirelessly communicate with the in-vehicle system 101 and/or the mobile device 109 to send and receive raw driving data. The plug-in adapter 206 may connect to the in-vehicle system 101, for example, via an OBD-II connector of the vehicle. The plug-in adapter 206 can access raw driving data via the OBD connector and communicate with one or more devices (e.g., the driving data server 105, the analyzer 108, user devices, emergency services 106, etc.) wirelessly via the communications interface 301. The plug-in adapter or Bluetooth beacon 206 can store the raw driving data in the memory 303 for predetermined durations of time and/or based on a size of the memory 303 and an amount of the raw driving data collected. In some embodiments, the plug-in adapter can process the raw driving data using the processor 302 for identifying the driver, determining one or more features used for distracted driving estimation and/or driver safety rating calculation such as trip duration, number of braking events, acceleration graphs, etc. and can send the processed raw driving data wirelessly to the driving data server 105, the distracted driving analyzer 108, emergency services 106, and/or other user devices.

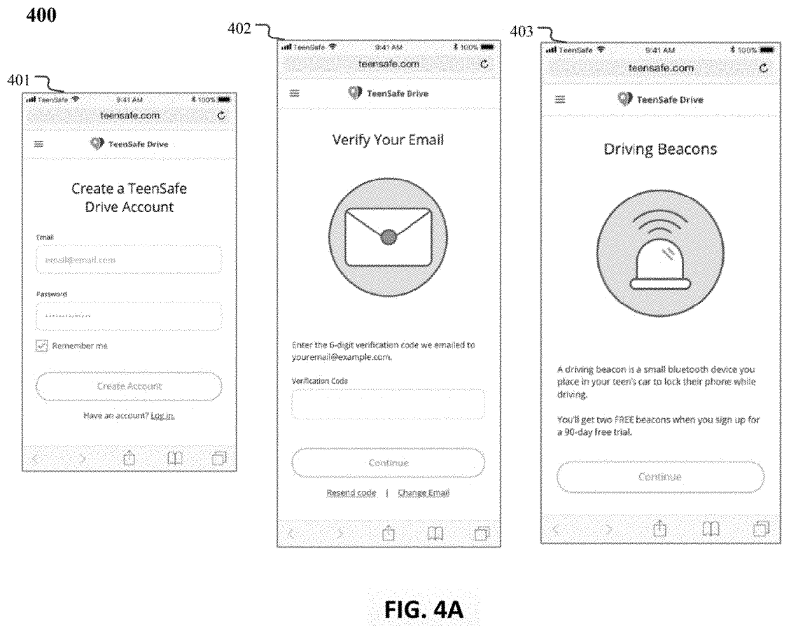

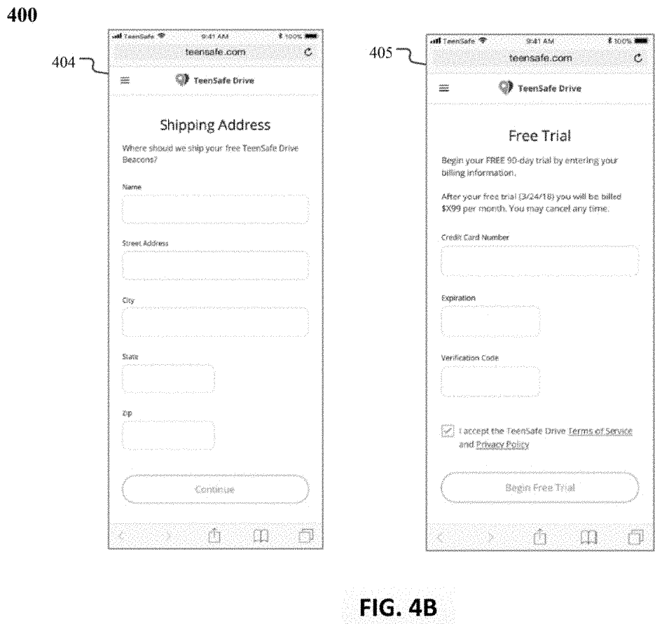

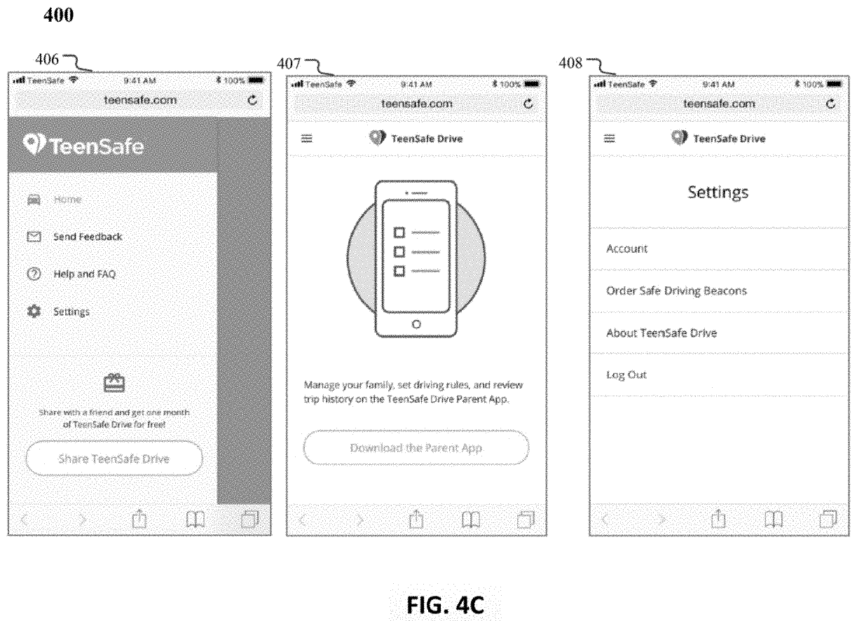

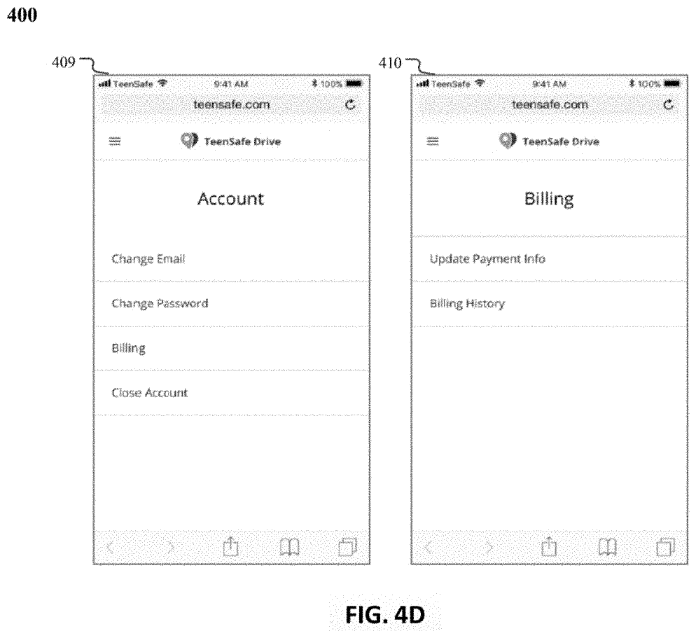

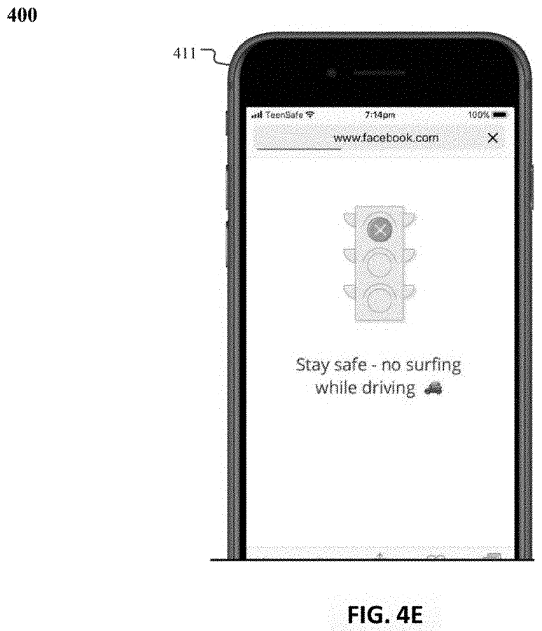

FIGS. 4A-E show examples of a GUI for the distracted driving application in accordance with certain embodiments. The user interface can provide an intuitive, engaging, and easy-to-follow user experience for reducing distracted driving, connecting with family, friends and communities, and availing of educational programs tied to driver safety rating incentives and/or distracted driving ratings.

FIG. 4A shows exemplary user interface screens 401 and 402 for registering and creating a user account in connection with the distracted driving prevention system. The user interface screen 403 of FIG. 4A provides information regarding the plug-in adapter or Bluetooth beacon 206 that the distracted driving prevention system can use for collecting driving data, identifying the driver, and/or identifying the mobile device 109 that can be locked or for which one or more applications can be selectively restricted.

FIG. 4B shows exemplary user interface screens 404 and 405 of the distracted driving prevention system 100 informing the registered user of free trial information, shipping time and/or shipping information after receiving shipping address information from the registered user.

FIGS. 4C-D shows exemplary user interface screens 406-410 for the distracted driving prevention system 100 associated with settings, account information, and billing information.

FIG. 4E shows an exemplary user interface screen 411 that can be indicative of a lock screen and a restricted application, such as Facebook respectively, that is shown when the distracted driving prevention system restricts access to an application on a mobile device. Through and as part of the inventive distracted driving prevention system, the initialized application on the driver's mobile device provides straightforward avenues for reducing distracted driving by restricting usage of the mobile device while in the vehicle.

The following examples of embodiments use a familiar parent-child relationship for illustration purposes only. One skilled in the art would recognize that various features and functionalities can apply to similar relationships in which there is a parent or “super” user who is provided with more access and control over a child or lower level user with less access and control. For example, a supervisor may be provided with a “parent” application while an employee under the supervisor's supervision may be provided with a “child” application.

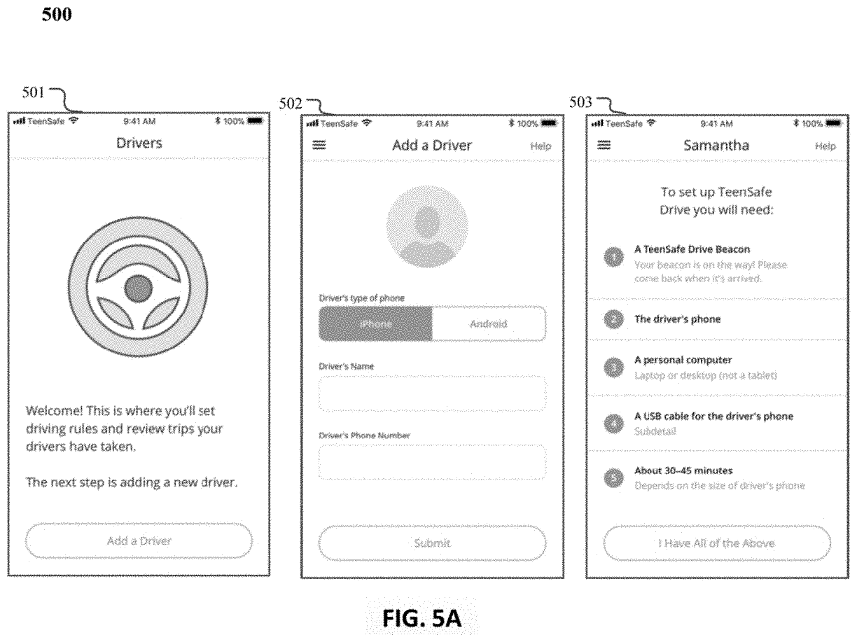

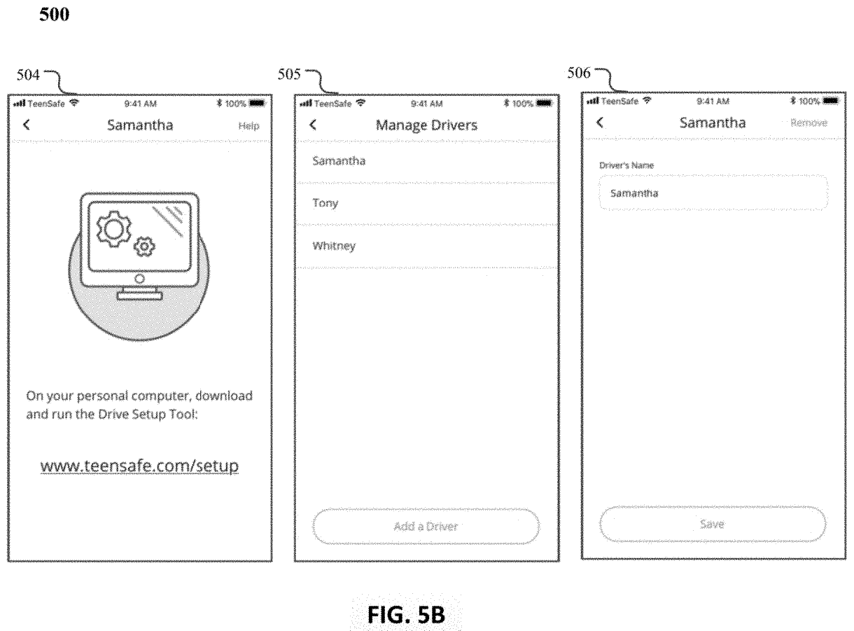

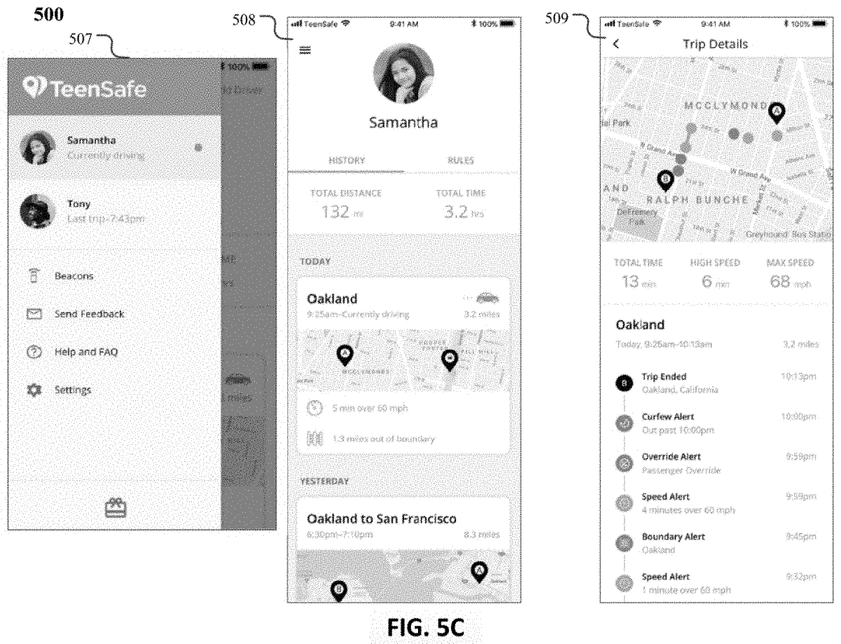

FIGS. 5A-C show examples of the user interface screens for the distracted driving prevention system 100 for a “parent application” that enables the user to have more control over the system, for example, to add one or more drivers, configuration how the user device(s) can be restricted, and/or to access driving data. User interface screens 501-506 show how the parent application can add a new driver for purposes of restricting access to the device(s) associated with the driver when driving. This is done by receiving the input data from the “parent” and storing the “children” data.

User interface screens 507-509 show the parent application monitoring driving data and/or location associated with the child application that may be installed on the added driver's mobile device. For example, the parent application can provide details (e.g., time, date, total driving time, total distance, highest speed driven, alerts triggered, etc.) of current and recent trips undertaken by the added driver. Accordingly, this parent application permits the “parent” user to monitor the “children” users.

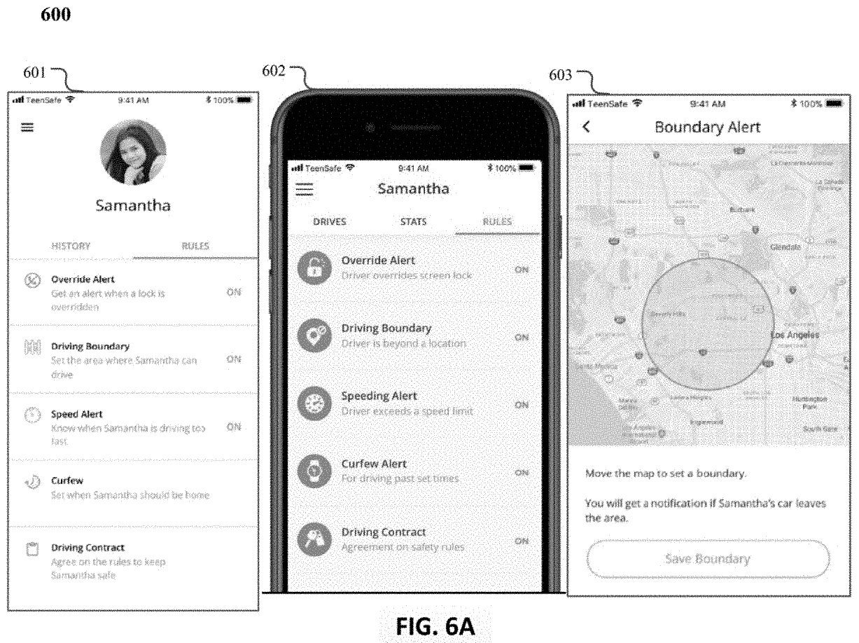

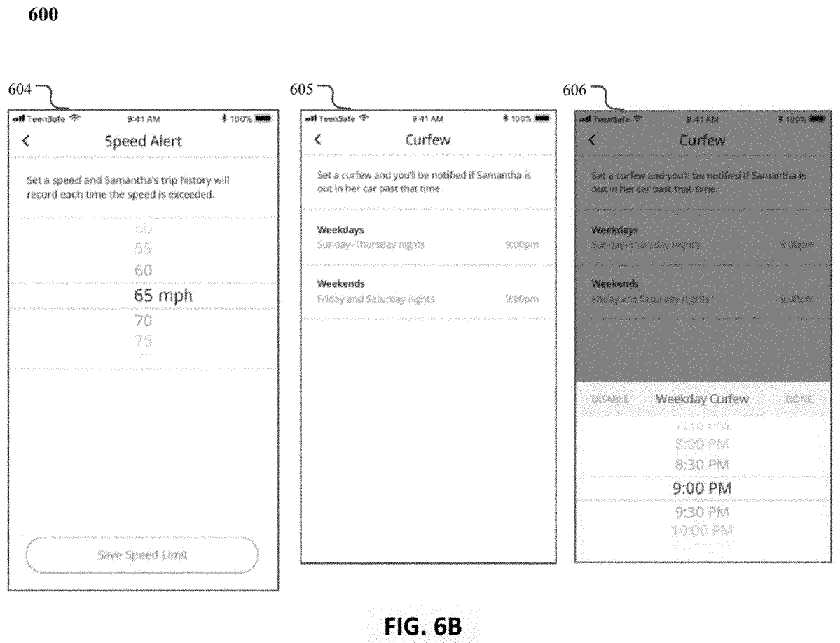

FIGS. 6A-B show examples of the user interface screens for the distracted driving prevention system 100 for setting rules and configuring corresponding alerts for purposes of enabling parents to monitor the driving behavior of their children. User interface screens 601 and 602 provide exemplary embodiments of setting rules associated with a driving boundary, speeding limits, curfew, driving contract and an override. User interface screen 603 shows how the distracted driving parent application can allow the registered user to set a driving boundary and a corresponding boundary alert if the mobile device associated with the child application crosses the set boundary. User interface screens 604-606 of FIG. 6B provide exemplary embodiments of setting rules and alerts related to speeding and curfews.

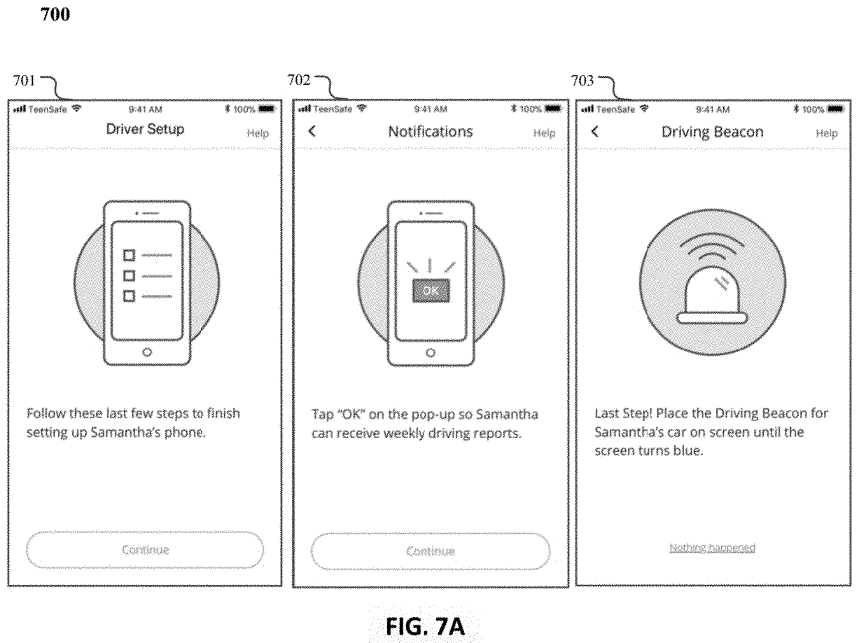

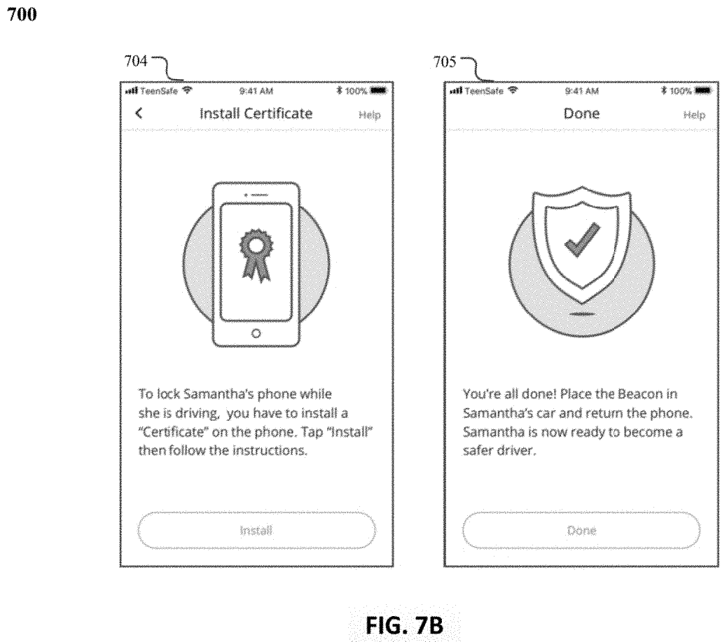

FIGS. 7A-B show examples of the user interface screen for the child application of distracted driving prevention system 100. For example, user interface screens 701-703 are indicative of steps a registered user can take for setting up the child application on the mobile device of the added driver and installing the plug-in adapter or beacon 206 in the vehicle to be monitored. As another example, user interface screens 704-705 show that the registered user may install a certificate (e.g., an enrollment certificate) on the child application's mobile device that enables the registered user to lock the mobile device of the added driver, if the added driver is driving, and remotely via the parent application.

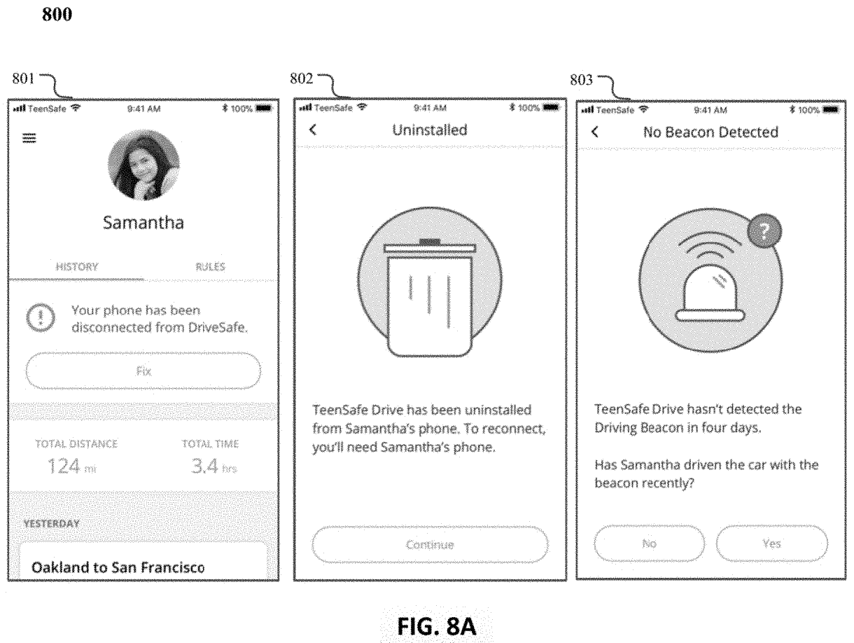

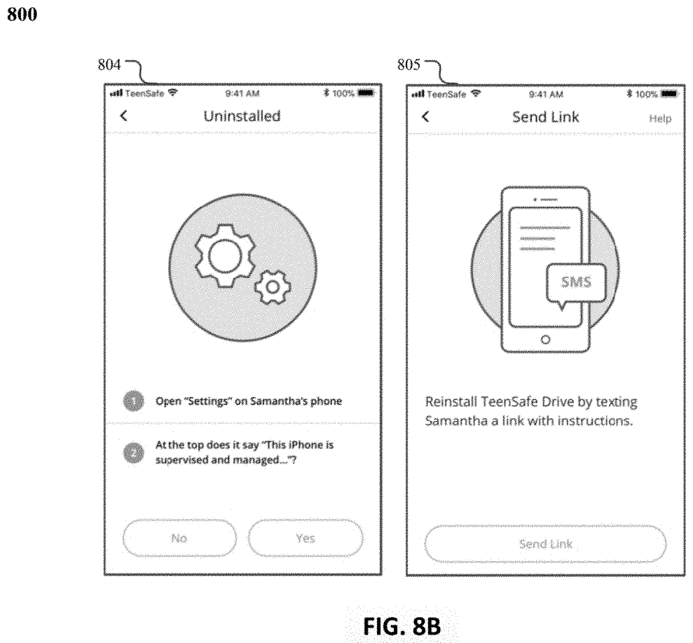

FIGS. 8A-B show examples of the user interface providing tamper alerts on the parent application that can be indicative of an attempt to circumvent monitoring and/or usage restriction of the mobile device by the distracted driving prevention system. For example, user interface screens 801-802 may be indicative of a disconnected mobile device or an uninstalled child application from the monitored mobile device. In some embodiments, an alert can be generated and sent to the parent application when the mobile device is disconnected or the child application is uninstalled.

As another example, user interface screen 803 may provide an indication that the child application has not detected the plug-in adapter or beacon 206 for a predetermined number of days (e.g., 4 days). The parent application may provide recommended courses of action for the registered user to make sure the child application is working correctly on the added driver's mobile device. For example, user interface screen 804 may provide the registered user with directions related to verifying whether the child application has been uninstalled. As another example, user interface screen 805 may provide instructions for the registered user to send the added driver's mobile device a text message including a link for reinstalling the child application. In some embodiments, the child application may be configured to restrict access until these issues are resolved except for when there is an emergency situation that overrides the restriction.

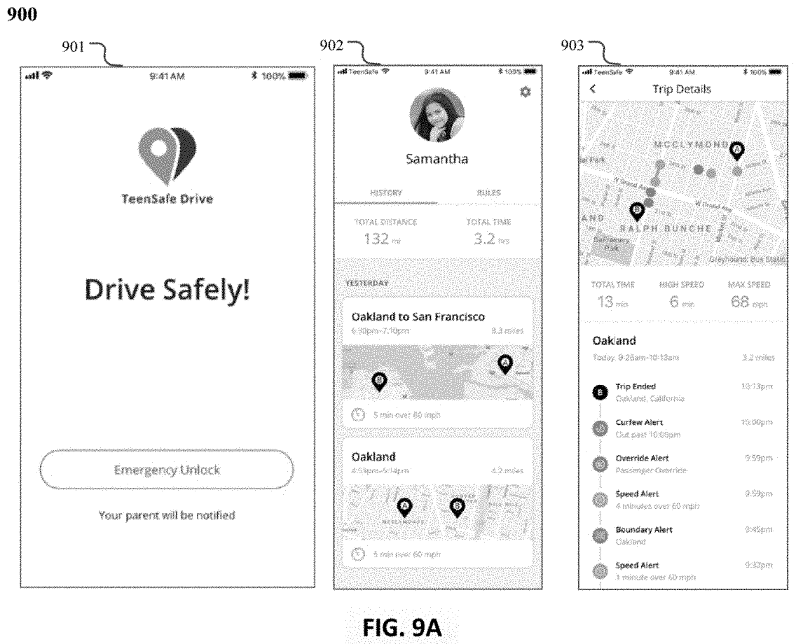

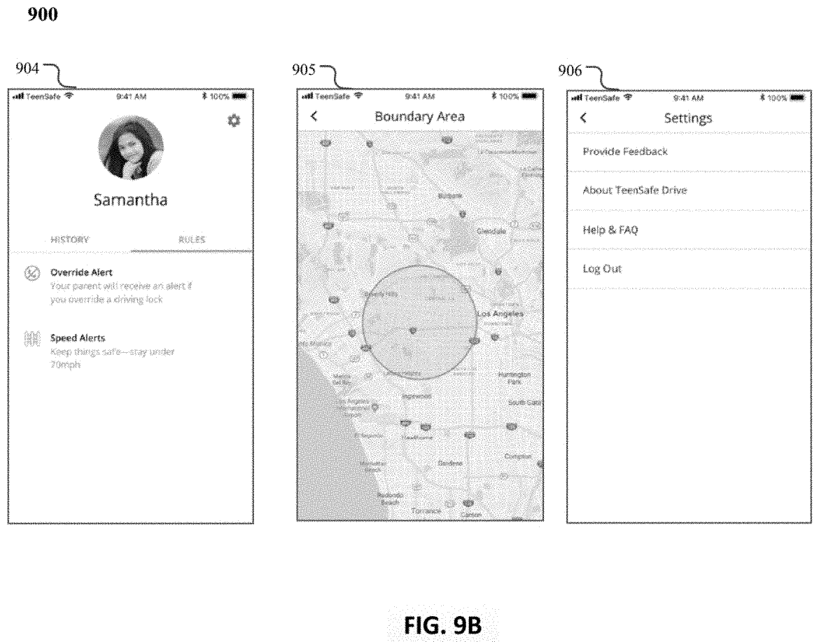

FIGS. 9A-B show examples of user interface screens 901-906 for the child application of the distracted driving prevention system once the child application has been set-up. For example, user interface screen 901 shows that the mobile device has been locked because the distracted driving prevention system has determined that the added driver may be driving as described above. The child application may provide a selectable emergency unlock feature and if this feature is selected, a notification may be sent to the parent application installed on a user device of the registered user.

As another example, user interface screens 902-903 show historical driving data (e.g., trips taken, distance traveled, duration of travel, location data of the trips, etc.) and/or alerts (curfew, speeding, boundary, override, etc.) triggered for the added driver. User interface screen 904 provides an example of rules that can be set for the child application associated with overrides and/or speed limits. User interface screen 905 shows a driving boundary area that has been set for the child application. If the added driver drives beyond this set boundary area, an alert will be generated and sent to the parent application.

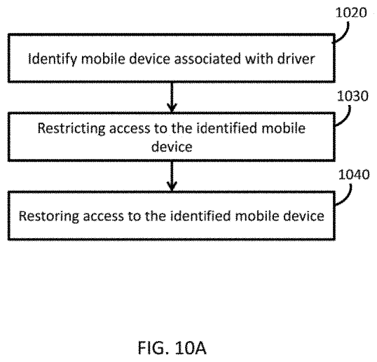

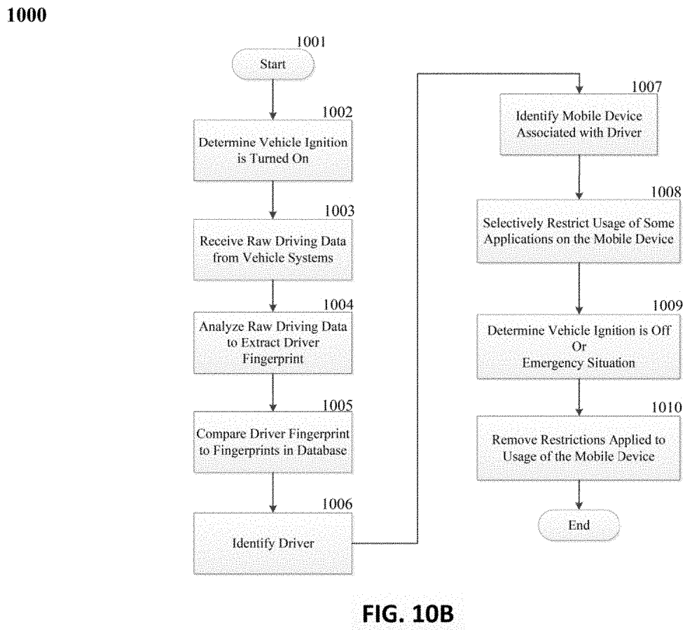

FIG. 10A shows an exemplary process flow for selectively disabling or restricting access to a mobile device that is associated with a driver to prevent the mobile device from distracting the driver while driving using the inventive distracted driving prevention system described herein.

At 1020, distracted driving prevention system 101 identifies one or more mobile devices that is associated with a driver. In some embodiments, the mobile device(s) can be configured to check if a Bluetooth beacon (e.g., beacon 206) is present. For example, the device(s) can be configured to listen for packet(s) transmitted by the beacon. This can be achieved, in some embodiments, by sending silent push notifications to the app installed on the mobile device(s) to wake the device up and check for the beacon. In some embodiments, the silent push notifications are sent via a voice-over-IP (VoIP) channel to allow the mobile device(s) to process these push notifications even when the app is running in the background. In some embodiments, the push notifications are sent every few seconds to wake the application from the background so it can check for the presence of the beacon.

It should be noted that the use of a beacon, such as a low energy Bluetooth beach, to detect whether the device is in a car provides a number of advantages over prior systems. For example, traditional means of determining whether a particular user is currently driving is to leverage GPS on the user's device. If the GPS shows that the user is traveling above a certain speed, it can be assumed that the user is in a vehicle. This approach, however, has a few key shortcomings. For one, constantly checking the phone's GPS has a significant impact on battery life, greatly impacting the user's experience. Secondly, while traveling above a certain speed might indicate that the user is in a vehicle, it does not differentiate between driving a car, being on a bus, or traveling on a train, and thus, the device may become locked under situations that may not impact a distracted driving scenario.

In some embodiments, the beacon can be provided as a standalone unit, powered by, for example, a battery. Such beacon can be configured to broadcast a signal constantly, for example, independent of the state of the car/ignition.

In some embodiments, the mobile device(s) can be configured to check upon detection of an ignition-on event. For example, the beacon can be powered by the vehicle and/or configured to detect when the vehicle has been turned on (e.g., part of plug-in adapter or beacon 206). Such beacon can be configured to send a signal to mobile devices upon being powered on, upon activation of the vehicle's ignition switch, or detection that the engine or motor is running, which in turn can enable the mobile device to determine when the vehicle has been turned on. The mobile device can be configured, in some embodiments, to transmit notification to driving data server 105 about the vehicle's power state. In some embodiments, the beacon can also be configured to continue to broadcast its signal after the vehicle has been powered off for a period of time (e.g., two minutes). Upon determining that the vehicle has been powered off, the mobile device can be configured to notify driving data server 105.

In some embodiments, each mobile device determines its proximity to the Bluetooth beacon, for example, using Bluetooth ranging. Each mobile device can be configured to transmit the proximity data to distracted driving prevention system 100, and based on the proximity, the system can determine if the mobile device is likely to be associated with the driver. Under this arangement, the system can determine, for example, which mobile device is the closest to the beacon and therefore most likely to be the operator of the vehicle.

The mobile device can be configured, in some embodiments, to constantly search or check for a beacon at a given frequency or for a specific period of time. In some embodiments, the mobile device can be configured to check for a beacon more frequently under certain conditions such as when the vehicle is turned on.

In some embodiments, upon detecting an ignition-on event, the mobile device can determine the phone's location and compare it to the GPS location of the adapter. In some embodiments, this can be facilitated by sending silent push notifications to the app to wake it up and check for the location. The push notifications can be sent, in some embodiments, via a VoIP channel.

When multiple mobile devices are present in the vehicle, the distracted driving prevention system can provide a number of ways to select which device(s) to “lock” (e.g., disable or restrict access) at 1030. For example, in some embodiments, all mobile devices that are present can be locked, and each device is provided with the ability to be unlocked by a user at 1040. In some embodiments, a user (e.g., an account owner) can select which device(s) to lock. In some embodiments, all devices that are present can be locked, and to unlock a device, a user must complete a task that would be difficult/impossible for a driver to do. For example, the task can be something that requires the use of both hands, perhaps touching the screen of the mobile device with both hands and orienting the device in such a manner that a driver could not feasibly complete the task. Another example can require the user to take a photo of themselves with the driver holding the wheel in the background. Although such tasks would cause distraction if the driver attempted to complete them, the task difficulty should be sufficient to deter the driver from attempting.

In some embodiments, the driver (and the devices associated with the driver) can be identified by analyzing driving behaviors (“driver fingerprint”) such as braking, accelerating, cornering, and speed, as well as contextual information such as time of day, route, the car being driven, who is in the car, which mobile device is using navigation software, other trips that day, physical distance from the beacon (e.g. using Bluetooth ranging), whether users are holding their mobile devices, and comparing available data to past behaviors and contexts to determine who is most likely to be the driver.

When a driver fingerprint is being used to determine the driver (and the associated mobile device(s)), the distracted driving prevention system can be configured to lock all devices at 1030 until the driver is identified, then unlock the non-drivers at 1040. In some embodiments, individual users and/or the account owner can unlock specific devices in the meantime. In some embodiments, all devices can be unlocked until the driver is identified by the distracted driving prevention system, and the system locks the device(s) associated with the identified driver.

In some embodiments, all locked devices are unlocked upon detection of an ignition-off event (e.g., car power turned off, ignition switch being turned off, engine rpm is zero).

FIG. 10B shows another example of a process flow for selectively disabling and/or restricting usage of one or more applications on the mobile device associated with a driver. The exemplary process 1000 may begin at block 1001 during which the distracted driving prevention system 101 is initialized. The distracted driving prevention system 101 may establish communication channels with various vehicle systems (e.g., the in-vehicle system 102, vehicle plug-in adapter or beacon 206, vehicle sensors, vehicle telematics unit, accelerometer, GPS, gyroscope, etc.), wireless devices, servers, and analysis systems for collecting driving data, third party driver data, and/or contextual data (e.g., real-time traffic feeds, real-time weather feeds, road conditions, etc.). The communication channels may comprise secure channels that send and receive encoded data. Various authentication protocols can be used for authenticating communication with the in-vehicle systems, sensors, and other devices to ensure data privacy.

At 1002, the distracted driving prevention system 100 may determine that the vehicle's ignition has been turned On. The distracted driving prevention system 100 may receive ignition information related to the vehicle from the vehicle plug-in adapter 206.

At 1003, driving data server 105 may receive driving data from in-vehicle system 101. This driving data may be analyzed by the distracted driving prevention system 100 at 1004 to extract a driver fingerprint based on unique driving patterns and driving styles of the driver that can help identify a driver of the vehicle. The distracted driving prevention system 100 may include a database of registered drivers that are each associated with a respective driver fingerprint based on the unique driving patterns and driving styles that has been collected by the distracted driving prevention system 100.

At 1005, the distracted driving prevention system 100 may compare the extracted driver fingerprint to the stored driver fingerprint in the driving data server 105. If there is a match, the system can identify the driver at 1006.

At 1007, the system may identify a mobile device respectively associated with the identified driver based on stored driver related information in the one or more system servers (e.g., 104 and 105) and as described earlier with respect to FIGS. 5A-B.

At 1008, the system may selectively restrict usage of one or more applications on the mobile device based on preselected blacklisted applications (e.g., messaging and gaming applications). For example, if the mobile device running the child application was configured to blacklist/restrict usage of the one or more applications by the parent application, then the child application can enforce restricted usage or block usage of the blacklisted applications. In some embodiments, the system may implement a method of filtering notifications generated by the mobile device so that notifications related to whitelisted applications (e.g., navigation and audio streaming) may be displayed while notifications related to blacklisted applications may be blocked. In some embodiments, the system may block or disable all applications of the mobile device except for the whitelisted applications.

In some embodiments, the system may lock or restrict access to the mobile device as described earlier with respect to FIGS. 4E and 9A. If more than one mobile device was detected by the beacon as described earlier, the system may lock all the mobile devices and/or request user input to determine which mobile device is to be locked. The system may cause the locked or restricted mobile device to generate auto-replies to text messages or calls if the mobile device has been locked or text messaging and call based applications have been disabled. The system can use a combination of virtual private network (VPN) technology and a mobile device management software (e.g., Apple Mobile Device Management) of the mobile device to disable the blacklisted applications, enable whitelisted applications, disable preselected notifications, and/or enable tamper detection. The VPN technology may enable the distracted driving prevention system to selectively block or allow data traffic to the mobile device.

In some embodiments, the system may employ incentives that allows the driver to earn virtual reward badges and/or points for safe driving behavior associated with implementing blacklisted application restrictions while driving. The system may generate in-vehicle audio feedback related such safe driving behavior and/or reward accumulation. In some embodiments, the distracted driving prevention system can also generate feedback data to be accessed by the parent application.

At 1009, the system may determine that the vehicle's ignition has been turned Off and/or the system may detect that an emergency situation has arisen. Vehicle ignition information may be received by the system from the vehicle plug-in adapter 206. In some embodiments, the system may determine that the emergency situation has arisen based on analysis of the driving data. For example, if the vehicle has experienced sudden deceleration and hard braking before coming to a standstill, the system may determine that the emergency situation is a crash or near-crash event.

At 1010, the system may disable and/or remove the restrictions placed on the one or more applications in response to detecting the emergency situation. For example, if the system determines that the vehicle has experienced a crash, the system may automatically disable the screen lock placed on the mobile at 1008 and/or allow for unrestricted usage of all the applications on the mobile device.

In some embodiments, a Mobile Device Management (MDM) service, such as Apple's MDM service, can be utilized by the distracted driving prevention system to deliver configuration profiles to the driver's device to “lock” (disable or restrict access to) the device. The configuration profiles can individually disable any number of applications on the device. When disabled, the application icon will no longer be visible and the user will have no way of opening those apps. The configuration profiles can also suppress notifications from any number of specified apps so that these notifications will not appear on the lock screen (if the device is locked) or as a banner (if the device is unlocked). Because the apps whose notifications are to be blocked must be specified, the distracted driving prevention system can be configured to query the device for a list of all installed apps and determine which apps are to be blocked. For both application and notification blocking, the MDM service can be used to either block everything or block only selected applications.

The use of aspects of Apple's Mobile Device Management protocol (e.g., blocking the Messages app, disabling notifications) requires placing the device into a “Supervised” mode. Ordinarily, placing a device into the Supervised mode requires the device to first be wiped of all content, which would be undesirable and unacceptable to most users. Thus, the present systems and methods provide a setup tool that enables the distracted driving prevention system to place the device into the Supervised mode without requiring the user to wipe the device.

The setup tool provided by the distracted driving prevention system can be run on a computer that is paired to the device. The setup tools can be configured to collect a backup of key configuration files, modify the appropriate files to designate the phone as supervised, and restore those files to the device.

In some embodiments, VPN filtering can be employed by the distracted driving prevention system to route all data through the system's VPN to block or resolve any requests based on IP/domain. In some embodiments, the VPN block can be configured as a blacklist mode (data is only blocked for a specified subset of apps on the device or domains) or as a whitelist mode (all data use is blocked except for a specific subset of apps or domains). To whitelist specific apps or websites requires the distracted driving prevention system to determine the specific domains associated with the whitelist apps or websites. To this end, the distracted driving prevention system can be configured, in some embodiments, to analyze web traffic for key apps and sites and to compile the list of domains or IPs.

When using the VPN block on its own, users can still unlock the device and open each app. However, if the app is blocked by the VPN, then no new content will load thereby limiting access to the application.

In some embodiments, a Bluetooth device (e.g., an OBD-II device) can be paired to the driver's device as a Bluetooth keyboard. For example, upon detecting the device has been unlocked, the Bluetooth device can send a keyboard shortcut command for locking the device (e.g., sending the device back to its lock screen and thus preventing interaction with any apps on the phone). Because the device is paired as a Bluetooth keyboard, the on-screen keypad of the device will no longer appear. Therefore, even if a user was able to access an app, the user would not be able to input any characters. By locking the screen and/or hiding the keyboard, the system can prevent the driver from interacting with their mobile device, thereby help preventing distracted driving.

In some embodiments, the device can be configured to use “Accessibility” features (such as those provided by the Android operating system) to block unwanted apps from opening and detecting when notifications are accessed. This can be used to prevent access to (1) all applications on the device, (2) all but specifically designated applications, or (3) only specifically-designated applications. In some embodiments, non-accessibility features can be used to close the notification shade (a standard Android OS feature where users can drag down from the top of the screen to see their list of recent notifications). In some embodiments, programmatic access to the do-not-disturb API, which can prevent the user from receiving notifications/alerts, can be used by the distracted driving prevention system.

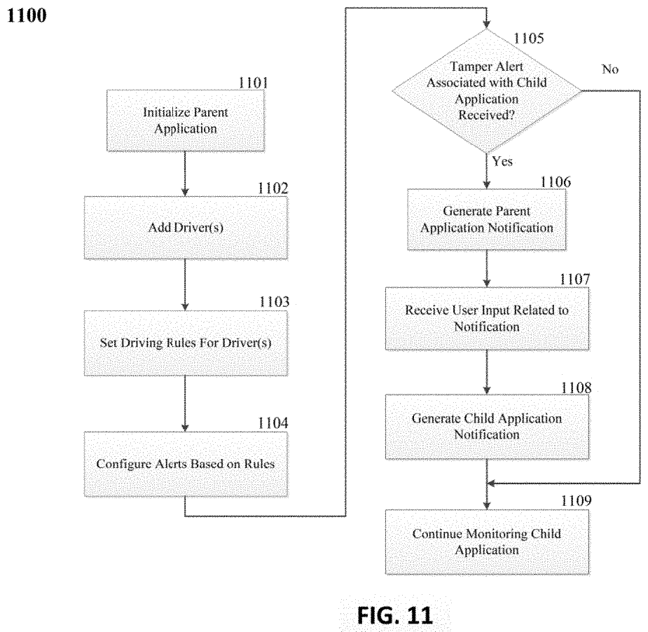

FIG. 11 shows an example of a flowchart for configuring rules and corresponding rule based alerts for monitoring a child application, via a parent application, of the distracted driving prevention system 100. The exemplary flowchart 1100 is provided by way of example, as there are a variety of ways to carry out methods according to the present disclosure. The method of flowchart 1100 shown in FIG. 11 can be executed or otherwise performed by one or a combination of various systems and modules. The method described below may be carried out by the distracted driving prevention system 100 shown in FIG. 1 and/or plug-in adapter 206 shown in FIG. 2, by way of example, and various elements of the system 100 and servers 104-105. Each block shown in FIG. 11 represents one or more processes, decisions, methods or subroutines carried out in exemplary method 1100, and these processes, decisions, methods or subroutines are not necessarily carried out in the specific order outlined in FIG. 11, nor are each of them required.

At 1101, the distracted driving prevention system can initialize the parent application installed on the one or more user devices 107a-b and/or establish communication channels between the parent application, the network 103, the one or more servers 104-105, the user devices 107a-b, and the child application installed on the mobile device 109. The communication channels may comprise secure channels that send and receive encoded data. Various authentication protocols can be used for authenticating communication with the in-vehicle systems, sensors, and other devices to ensure data privacy.

At 1102, the distracted driving prevention system may communicate with the parent application as described earlier with respect to FIGS. 5C and 6A-B and/or register a driver with the system. Driver information including name, corresponding vehicle information (e.g., make, model, number of miles driven, servicing information, etc.), and/or mobile device information on which the child application is to be installed may be entered into the parent application during registering the additional driver.

At 1103, the distracted driving prevention system may establish various rules related to curfew times, driving speed limits, overrides for locked applications, highway driving restrictions, and/or driving boundary areas associated with driving data collected by the child application as described earlier with respect to FIGS. 6A-B. The distracted driving prevention system may request the parent application to present to the registered user an “enrollment certificate” option that allows remote locking of the mobile device if the driver is observed to be driving as described earlier with respect to FIGS. 7A-B.

At 1104, the distracted driving prevention system may receive inputs from the parent application associated with the configuring of alerts on the parent application that correspond to the various rules. The registered user may enable and/or disable alert notifications for one or more rule infractions as described earlier with respect to FIG. 6A.

At 1105, the system may determine whether a tamper alert has been triggered indicative of the child application being uninstalled, disabled, and/or loss of connectivity between the plug-in adapter or beacon 206 with the system. If no tamper alert has been received, No at 1105, the system may proceed to 1109. If a tamper alert has been received, Yes at 1105, the system may proceed to 1106.

At 1106, the system may generate a notification related to the tamper alert on the parent application as described earlier with respect to FIGS. 8A-B. For example, the system may generate a notification indicative of the child application being uninstalled from the mobile device. The system may then cause the parent application to present a corrective course of action. For example, the system can allow the parent application to send a reinstallation link to the mobile device so that the driver can reinstall the child application. As another example, the system may generate a notification indicative of the mobile device being disconnected from the distracted driving prevention system.

At 1107, the system may receive a user input related to the tamper notification from the parent application. For example, the system may receive a user input indicative of a request to send the reinstallation link to the mobile device.

At 1108, the system may cause the mobile device to present a notification to the driver related to the tamper alert and/or the user input from the parent application. The notification may be associated with the reinstallation link for the child application.

At 1109, the system may continue monitoring data for the child application. For example, the system may verify that the child application is supervised and managed correctly and continue analyzing the driving data provided by the child application. The system may generate weekly reports and/or insights related to the analyzed driving data. The weekly reports or insights can help the driver and other registered users improve safe driving habits, a safe driving rating, and/or gain additional insights into aggregated trip details.

It will also be appreciated that one or more of the elements depicted in the drawings/figures may also be implemented in a more separated or integrated manner, or even removed or rendered as inoperable in certain cases, as is useful in accordance with a particular application. It is also within the spirit and scope to implement a program or code that may be stored in a machine-readable medium, such as a storage device, to permit a computer to perform any of the methods described above.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

While there have been described methods for providing a user interface to a user capable of a set of interactivity features in a variety of operational modes, it is to be understood that many changes may be made therein without departing from the spirit and scope of the invention. Insubstantial changes from the claimed subject matter as viewed by a person with ordinary skill in the art, no known or later devised, are expressly contemplated as being equivalently within the scope of the claims. Therefore, obvious substitutions now or later known to one with ordinary skill in the art are defined to be within the scope of the defined elements. The described embodiments of the invention are presented for the purpose of illustration and not of limitation.

What is claimed is:

1. A method for distracted driving prevention using a distracted driving prevention system, the method comprising:
receiving ignition information from a vehicle plug-in adapter that an ignition of a vehicle is on;
receiving raw data from an in-vehicle system to identify a driver of the vehicle;
identifying the driver of the vehicle;
identifying a mobile device associated with the driver; and
applying restrictions to the usage of the mobile device associated with the driver.

2. The method of claim 1, wherein a user registers for distracted driving prevention system.

3. The method of claim 1, further comprising:
analyzing the received raw data to extract a driver fingerprint; and
comparing the extracted driver fingerprint to stored driver fingerprints in a driving data server to identify the driver.

4. The method of claim 3, wherein the received raw data is based on unique driving patterns and styles.

5. The method of claim 3, wherein the driving data server includes a database of registered drivers.

6. The method of claim 1, further comprising:
receiving ignition information from a vehicle plug-in adapter that an ignition of a vehicle is off; and
removing applied restrictions to the usage of the mobile device associated with the driver.

7. The method of claim 1, further comprising:
detecting an emergency situation; and
disabling the applied restrictions to the usage of the mobile device associated with the driver in response to detecting the emergency situation.

8. The method of claim 1, wherein the driver overrides the restrictions.

9. The method of claim 2, wherein the user is the driver.

10. The method of claim 2, wherein the user is a parent of the driver.

11. A distracted driving prevention system, the system comprising:
a mobile device associated with a driver of a vehicle;
an in-vehicle system for providing driver data associated with the driver;
a distracted driving analyzer for analyzing the driver data and generating drive data profiles;
a driving data server for storing the drive data profiles;
a plug-in adapter for communicating with the in-vehicle system and the mobile device to restrict usage of the mobile device associated with the driver when the in-vehicle system determines that the ignition is on.

12. The distracted driving prevention system of claim 11, wherein the plug-in adapter further comprises a communication interface, a processor, and a memory.

13. The distracted driving prevention system of claim 12, wherein the memory stores raw driving data.

14. The distracted driving prevention system of claim 11, wherein the plug-in adapter transmits driving data to the driving data server and the distracted driving analyzer.

15. The distracted driving prevention system of claim 11, wherein the plug-in adapter processes raw data to identify a driver of a vehicle.

16. The distracted driving prevention system of claim 11, wherein a fingerprint is generated based on the drive data profile.
